(19) United States
(12) Patent Application Publication
(10) Pub. No.: US 2026/0177407 A1
(43) Pub. Date: Jun. 25, 2026

(54) Incremental magnetic encoder

(71) Applicant: THALES, Meudon (FR)

(72) Inventors: Mathieu BESNARD, MERIGNAC (FR); Frédéric SANSON, MERIGNAC (FR)

(21) Appl. No.: 19/431,228

(22) Filed: Dec. 23, 2025

(30) Foreign Application Priority Data
Dec. 24, 2024 (FR) FR2415218

(51) Int. Cl. G01D 5/20; G01D 5/245

(52) U.S. Cl. CPC G01D 5/2046; G01D 5/2451; G01D 2205/24

(57) ABSTRACT

An incremental magnetic encoder includes a fixed body and a movable body. One of the bodies, referred to as the first body, includes a first toothed component extending in a longitudinal direction and a circumferential direction, one of the directions corresponding to a first encoding direction. The other body, referred to as the second body, includes a second toothed component defining a tooth made of magnetic or ferromagnetic material and arranged facing teeth of the first toothed component. A pair of magnetic coils are configured to measure each variation in inductance between the first toothed component and the second toothed component, to quantify each movement of the movable body along the first encoding direction.

### FIELD OF THE INVENTION

This invention relates to an incremental magnetic encoder.

More particularly, the present invention relates to an encoder capable of providing binary logic signals representing increments of relative position of two elements of the encoder, the two elements being movable relative to each other. Advantageously, such an encoder is applicable in the aeronautical field, for example in an aircraft cockpit.

Typically, in an application for aeronautical equipment, an angular and/or linear encoder can be used to indicate to an autopilot computer an altitude or speed set point that the operator selects by pressing an encoder control knob. The reliability of the encoder and the information it delivers is therefore an essential element of the encoder. The typical requirement for an aeronautical encoder may include one or more of the following: compactness, ability to make multi-turn rotations and/or a linear stroke, incrementing and detent capability, etc. In order to be certified, the aeronautical encoder must also be able to meet high DAL (Design Assurance Level) safety levels, in particular DAL A.

In particular, with regard to compactness, an encoder typically has a control knob with a diameter of between 10 and 100 mm and a length of between 5 and 50 mm (typically ø 16 mm×Ig 16 mm) and a body with a diameter of between 10 and 100 mm and a length of between 5 and 100 mm (typically ø25 mm×Ig 50 mm) hidden behind the fixing panel or fixed in front of this panel. In the latter case, the knob encompasses the body of the encoder which is fixed to the panel and allows it to be positioned around, or even slightly overlapping, a monitor or screen.

In terms of incrementing capacity, each detent position (or step) constitutes an increment of a rotation or translation counting unit. Angular or linear resolution is defined by the step (or detent position). The number of steps per revolution is between 1 and 32 steps (typically 12 steps). The number of translation steps is between 1 and 10 detent position (typically 1 detent position in each direction to obtain a push/pull knob with a stable state between the two detent position).

To detect the direction of movement in rotation and/or translation, the encoder generally has at least two detectors (for rotation and translation respectively) physically offset from each other (typically an odd number of quarter steps). These two detectors encode rotational and/or translational movement in two bits. The encoding gives the following successive values: 00, 01, 11, 10 when the encoder rotates and/or translates in one direction and the following successive values: 00, 10, 11, 01 when the encoder rotates and/or translates in the opposite direction. It is therefore possible to determine not only the occurrence of a rotational and/or translational increment (change of state of one of the bits) but also the direction of rotation (by comparison between a detected state and the immediately preceding state).

With regard to the detent capability of encoders, going past an encoded detent position generally results in tactile feedback that an operator should feel when operating the device. For example, the angular detent torque can be in the order of 1 to 700 mN·m (typically 12 mN·m) and the linear detent force in the order of 0.5 to 20 N (typically 6 N).

The most complex encoders feature encoding and detent in both rotation and translation. Encoding and detent in rotation must not be inhibited by encoding and detent in translation. In this case, detection and detent in both rotation and translation must be able to be used simultaneously without loss of performance. For example, to enter a speed, the driver must simultaneously push the encoder knob and turn it to the chosen value.

Finally, in some cases, to secure the encoder and in particular to guarantee its DAL security level (for example DAL A), the detection (or encoding) functions are at least doubled.

### PRIOR ART

To meet the above requirements, the encoders used in aerospace applications are often based on opto-mechanical solutions (optical detection and mechanical detent) or electromechanical solutions (detection by electrical contact and mechanical detent) and sometimes magneto-mechanical solutions (magnetic detection and mechanical detent) or opto-magnetic solutions or even purely magnetic solutions.

For example, opto-mechanical encoders are described in documents FR 2937129 and FR 2954491. According to these documents, an optical encoder is used to detect rotation and/or translation (encoding), while at least one ball pressed by a spring against a ball track (or cam) is used to hold it in a stable position (detent). Although these latest innovations meet the needs described above and aim to simplify their production, opto-mechanical and electromechanical encoders remain complex assemblies made up of numerous high-precision parts.

More generally, current mechanical detent solutions generate friction (e.g. ball against cam) and wear, which limits the life of the device, particularly when plastic parts are used. In electromechanical encoders, detection and detent are sometimes linked by at least one common mechanical part which is used for both click and detection via an electrical contact. The latter is often exposed to the risk of wear and fretting corrosion, which limits the life of the device. In addition, in opto-mechanical and sometimes electromechanical devices, detection and detent are decoupled, i.e. they result from different solutions and/or phenomena and are quite far apart physically. This decoupling increases the number of parts and therefore the risk of a mismatch between detection and detent. In the case of complex and secure encoders, the number of parts is even greater. In this case, to ensure good performance and reliability, today's complex encoders require high-precision parts, which are more expensive.

Document FR 2370350 is also known, describing a rotary magnetic encoder with moving magnets wherein detent and encoding are derived from the magnetic phenomenon. However, the encoder in this document is only rotary and uses moving magnets which are exposed to the risk of rubbing and jamming.

To sum up, electromechanical solutions present the greatest risk of fatigue in both detent and encoding, as they generate the most friction. The electrical encoding is also exposed to fretting corrosion. These drawbacks reduce reliability and limit the device's lifespan.

Opto-mechanical and magneto-mechanical solutions preserve the risk of fatigue in mechanical detent.

Opto-magnetic solutions use different contactless phenomena. These solutions are more cumbersome if the desire is to make a more complex encoder (e.g. rotary encoder with push/pull) that is also more secure.

Lastly, document FR 3135791 offers a purely magnetic solution enabling encoding to be implemented in one of the directions chosen, for example from the direction of translation and the direction of rotation, while ensuring detent in the same direction. According to this document, encoding and detent are created by the same magnetic effect between the movable body and the fixed body. This document therefore resolves all the issues mentioned above. However, the solution proposed in this document can still be improved, particularly in terms of form factor and reliability.

### SUMMARY OF THE INVENTION

The purpose of the present invention is to offer an incremental encoder that meets all the above-mentioned requirements, while improving the solution offered in particular by document FR 3135791, particularly in terms of form factor and reliability.

To this end, the invention relates to an incremental magnetic encoder defining an encoder axis and comprising a fixed body and a body movable relative to the fixed body in at least a first encoding direction;
one of the bodies, known as the first body, comprising:
   a first toothed component extending in a longitudinal direction coincident with the encoder axis and a circumferential direction perpendicular to the longitudinal direction, one of said directions corresponding to the first encoding direction, the first toothed component defining a plurality of teeth made of magnetic or ferromagnetic material and arranged along the first encoding direction;
the other body, known as the second body, comprising:
   a second toothed component extending in the longitudinal direction and the circumferential direction, the second toothed component defining a tooth made of magnetic or ferromagnetic material and arranged facing the teeth of the first toothed component during each movement of the movable body in the first encoding direction;
   at least one pair of magnetic coils configured to measure each variation in inductance between the first toothed component and the second toothed component, to quantify each movement of the movable body in the first encoding direction.

Equipped with these features, the encoder according to the invention can be used for coding in at least one of the directions chosen, for example from the direction of translation and the direction of rotation, without the use of a specific sensor. According to the invention, the use of teeth made of magnetic or ferromagnetic material makes it possible to vary the inductance when the movable body moves relative to the fixed body. This variation can be detected by the magnetic coils, which perform the function of the magnetic sensors traditionally used in encoders operating by the magnetic effect. The magnetic coils can also be used to provide an additional function, such as a detent torque and/or force. In this way, the number and size of the encoder's internal components can be significantly reduced.

In addition, the respective arrangement of the movable body and the fixed body can be chosen so as to minimise their mechanical contact. For example, the above-described elements of the fixed body and movable body have no mechanical contact with each other. As a result, these components operate without friction and without premature mechanical wear. This ensures that the encoder is reliable in use and considerably extends its service life, even when plastic parts are used. What's more, there are only a limited number of these elements, so they can be easily placed within the corresponding bodies. This makes assembling the encoder particularly simple and reduces the risk of parts jamming or shifting.

It is also clear that none of the toothed components show magnetic alternation in the first encoding direction.

According to other beneficial embodiments of the invention, the magnetic encoder comprises one or more of the following features, taken in isolation or in any technically possible combination:
the teeth of the first toothed component are arranged along the first encoding direction at a constant pitch;
the first encoding direction corresponds to the circumferential direction;
the second toothed component comprises a plurality of teeth arranged in the circumferential direction facing the teeth of the first toothed component, synchronously or out of phase;
the movable body is movable relative to the fixed body in a second encoding direction perpendicular to the first encoding direction;
the first toothed component also defines a plurality of teeth made of magnetic or ferromagnetic material and arranged along the second encoding direction;
the second toothed component defines a tooth made of magnetic or ferromagnetic material and arranged facing the teeth of the first toothed component during each movement of the movable body in the second encoding direction;
at least one pair of magnetic coils is configured to measure each variation in inductance between the first toothed component and the second toothed component, to quantify each movement of the movable body in the second encoding direction;
wherein the first toothed component comprises a plurality of toothed wheels arranged along the encoder axis;
the toothed wheels are spaced apart to form a plurality of teeth along the encoder axis;
the second toothed component comprises at least one toothed wheel arranged coaxially with at least one toothed wheel of the first toothed component at least in a rest position of the encoder;
the encoder comprises a plurality of magnetic coils arranged circumferentially on the toothed wheel of the second toothed component;
each magnetic coil extends around a pair of teeth formed by the toothed wheel of the second toothed component;
the second toothed component comprises at least two toothed wheels arranged along the encoder axis;
at least one magnetic coil is arranged between said toothed wheels of the second toothed component and extends around the encoder axis;
the encoder comprising at least two first toothed components arranged along the encoder axis and at least two second toothed components arranged coaxially with the first toothed components;
each first toothed component comprises at least one toothed wheel;
the toothed wheels corresponding to different first toothed components are out of phase by a predetermined angle;
the magnetic coils are configured to be energised during the operation of the encoder, to create a torque or a detent force between the first toothed component and the second toothed component during each respective movement of these components in the first encoding direction and/or a second encoding direction;
the magnetic coils are configured to be energised as a function of a context of use of the encoder or to generate haptic feedback;
the number of detent positions in an encoding direction is determined by the number of teeth of the first toothed component or of the second toothed component along this encoding direction;
the encoder further comprises one or more permanent magnets arranged to reinforce the detent torque and/or force and/or generate a return torque and/or force.

It is also clear that none of the toothed components show magnetic alternation in the second encoding direction. In other words, none of the toothed components have a magnetic alternation in either the first or the second encoding direction.

### DESCRIPTION OF THE FIGURES

These characteristics and advantages of the invention will become apparent upon reading the following description, which is given solely by way of a non-limiting example, with reference to the attached drawings, wherein:

FIG. 1 is a schematic perspective view of a magnetic encoder according to a first embodiment of the invention, the encoder being partially fixed behind a panel forming a dashboard;

FIG. 2 is an exploded perspective view of the encoder of FIG. 1, the encoder comprising a fixed body comprising a stator and a movable body comprising a rotor;

FIG. 3 shows a partial view of a section along the longitudinal plane Ill shown in FIG. 1;

FIG. 4 is an exploded perspective view of the stator and rotor shown in FIG. 2;

FIGS. 5 and 6 are detailed views of the rotor shown in FIG. 2;

FIG. 7 is a perspective view of a part of the stator shown in FIG. 2;

FIGS. 8A and 8B are diagrams explaining how the element shown in FIG. 7 works;

FIGS. 9A to 9C are views similar to FIG. 3 showing optional features of the encoder shown in FIG. 1;

FIG. 10 is a view similar to that of FIG. 3 showing a magnetic encoder according to a second embodiment of the invention, the encoder comprising a fixed body comprising a stator and a movable body comprising a rotor;

FIG. 11 is an exploded perspective view of the stator and rotor shown in FIG. 10;

FIGS. 12 and 13 are detailed views of the rotor shown in FIG. 10;

FIG. 14 is a perspective view of an element of the stator shown in FIG. 10;

FIGS. 15A to 15C is a view similar to FIG. 3 showing optional features of the encoder shown in FIG. 10; and

FIG. 16 is a schematic view of a pair of toothed wheels according to an embodiment other than those described in relation to the previous figures.

### DETAILED DESCRIPTION OF THE INVENTION

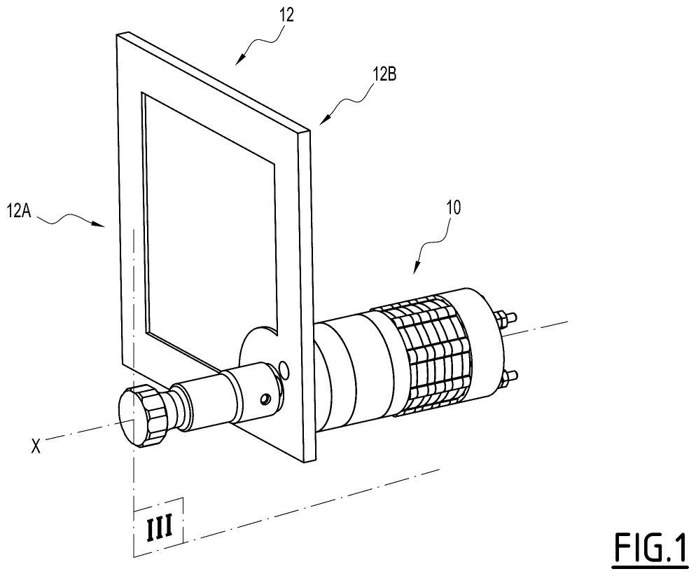

FIG. 1 illustrates an incremental magnetic encoder 10 according to a first embodiment of the invention. Preferably, the encoder 10 is mounted in a cockpit for piloting an aircraft.

By “aircraft” we mean any flying machine, such as an aeroplane, helicopter or drone. Such an aircraft can be flown directly from it. In this case, the cockpit is advantageously arranged inside the aircraft. In another example, such an aircraft is controlled remotely. In this case, the cockpit is located at a distance from the aircraft and has a ground station, for example. In all cases, the aircraft is configured to be piloted by an operator, for example by a pilot from the cockpit inside the aircraft.

According to the invention, the encoder 10 enables the operator to control at least one avionics function. For example, such an encoder 10 can be used by the operator to control an avionics system and forms part of a control system for such an avionics system. Alternatively, the encoder 10 forms part of a control system for several avionics systems. For example, the encoder 10 according to the invention forms part of a system known as a “Flight Control Unit” (FCU) or “Integrated Standby Instrument System” (ISIS) or “Closer Control Device” (CCD) or “Keyboard Cursor Control Device” (KCCD), etc.

In the example shown in FIG. 1, the encoder 10 is partially integrated in a panel 12. This panel 12 forms, for example, an aircraft cockpit instrument panel for one of the aforementioned control systems. In the example shown in FIG. 1, the encoder 10 is arranged partly in the front part 12A of the panel 12 and partly in the rear part 12B of this panel 12. In particular, in the example shown in FIG. 1, the front part 12A of the panel 12 faces the operator, while the rear part 12B of this panel faces the inside of the dashboard. Of course, other examples of arrangement of the encoder 10 in relation to the panel 12 or in relation to any other attachment means are also possible. In particular, according to another possible embodiment (not shown), the encoder 10 is located entirely in the front part 12A of the panel 12.

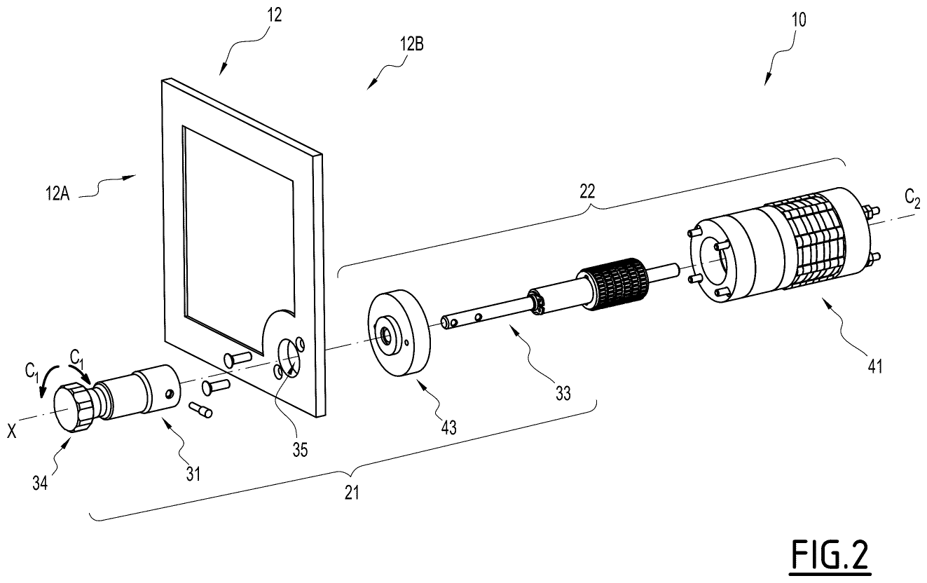

With reference to FIG. 2, the encoder 10 comprises a movable body 21, also referred to in this example as the first body, and a fixed body 22, also referred to in this example as the second body.

The movable body 21 comprises a knob 31 and a rotor 33.

The knob 31 projects from the panel 12 and is arranged in the front part 12A of the panel 12. The knob 31 can move in translation along an encoder axis X and in rotation about the encoder axis X. More particularly, the knob 31 is movable in a first encoding direction C1, which in this example corresponds to the direction of rotation about the encoder axis X, and a second encoding direction C2, which in this example corresponds to the direction of translation along the encoder axis X. Advantageously, the knob 31 is movable in each direction along each encoding direction C1, C2. In particular, in the direction of rotation, the knob 31 is rotatable clockwise and counter-clockwise, and in the direction of translation, the knob 31 is movable in the direction towards the instrument panel and towards the operator. Advantageously, the knob 31 defines in particular a knob surface 34 which is intended to be oriented towards the operator. This surface 34 therefore represents an external surface of the knob 31 which is visible to the operator and can be grasped by the operator.

The rotor 33 extends along the encoder axis X so as to form an integral connection with the knob 31 at one of its ends. In the same way as the knob 31, the rotor 33 can move in the first encoding direction C1 and in the second encoding direction C2 in each of the aforementioned directions of movement. The rotor 33 receives internal functional elements from the movable body 21, which will be explained in more detail later.

The fixed body 22 comprises a stator 41 and a flange 43.

The flange 43, for example, is located in a through-hole 35 in the panel 12 and supports the knob 31 and rotor 33. In the example shown in FIG. 2, the flange 43 is fixed to the panel 12 while remaining in the rear part 12B of the panel, for example using screws accessible from the front part 12B of the panel 12.

The stator 41 receives and/or comprises functional internal elements of the fixed body 22 which are intended to cooperate with the functional internal elements of the movable body 21 as will be explained in more detail later. In particular, and as will become apparent later, the functional internal elements of the fixed body 22 are held by the stator 41 at a distance from those of the movable body 21. To do this, the stator 41 is configured to at least partially receive the rotor 33 with the functional internal elements of the movable body 21 carried by this rotor 33. In another embodiment (not shown), the rotor 33 is configured to at least partially receive the stator 41 with the corresponding functional internal elements. This embodiment can be used, for example, when the encoder 10 is located entirely in the front part 12A of the panel 12.

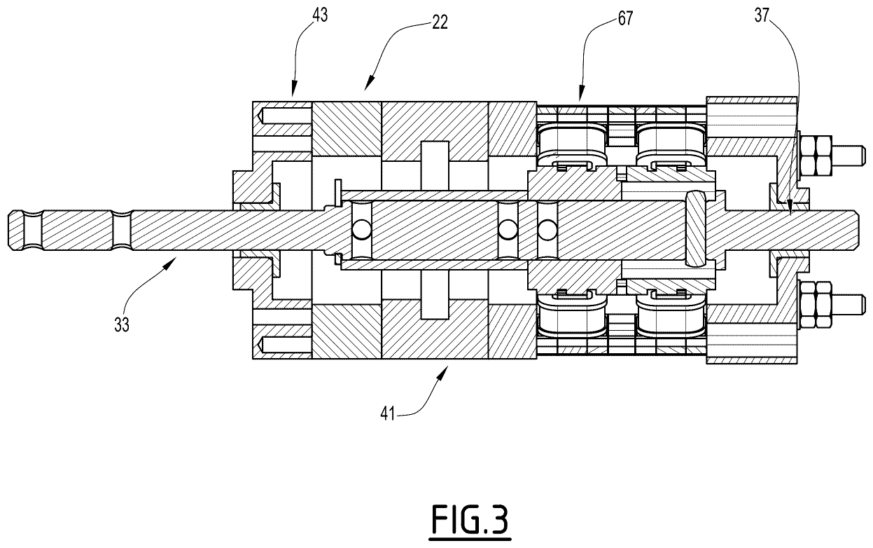

The stator 41, for example, is connected to the movable body 21 via a link that is movable in each encoding direction. For example, this connection may be formed at each end of the rotor 33 and have plain bearings, for example polymer bearings or sintered bronze bearings. These bearings are preferably flanged to act as a mechanical stop in both directions of movement of the rotor 33 along the encoder axis X. According to another example, these bearings are rolling element bearings such as a ball bushing. FIG. 3 shows the bearings 37 connecting the rotor 33 to the second body 22. In this example, the bearings 37 connect one end of the rotor 33 directly to the stator 41 and the other end of the rotor 33 to the stator 41 via the flange 43. In this example, the flange 43 is configured to cooperate with the stator 41 in order to secure it to the panel 12. The stator 41 may consist of several parts stacked along the encoder axis X.

In addition, a cover can be provided to protect all the components of the encoder 10 which are arranged in the rear part 12B of the panel 12.

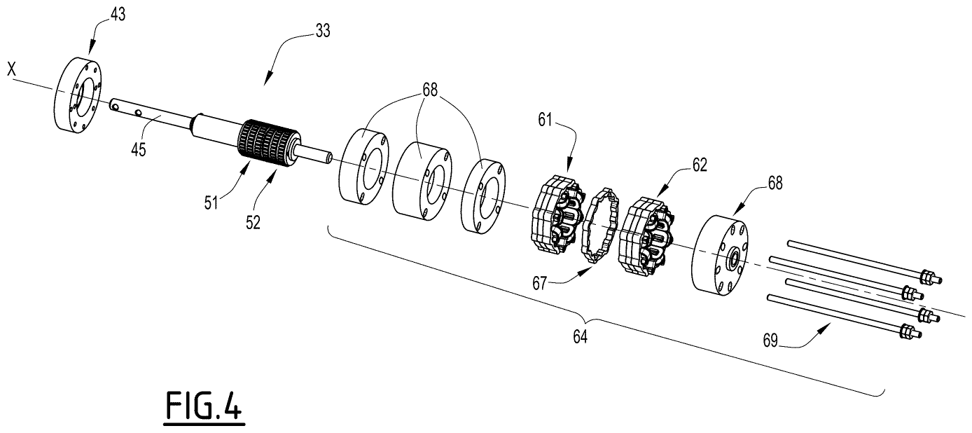

In the example shown in FIG. 4 illustrating in more detail the internal functional elements of the fixed body 22 and the movable body 21, the rotor 33 has, for example, a cylindrical shaft 45 extending along the encoder axis X.

With reference to FIGS. 4 to 6, the functional internal elements of the movable body 21 comprise at least two toothed rotor components 51, 52. Each of these components 51, 52 is fixed to the shaft 45 along the encoder axis X and remains spaced from the other component 51, 52 by a distance d. In some embodiments, the toothed rotor components 51, 52 are fixed to the shaft 45 by means of a spacer 53 and a snap ring. The components 51, 52 can be secured against rotation by means of keys or pins. The shaft 45 and spacer 53 are preferably made of a non-magnetic material (e.g. bronze alloy) to prevent magnetic leakage.

Each of the toothed rotor components 51, 52 is made of a magnetic or ferromagnetic material and comprises a plurality of toothed wheels 57 arranged along the encoder axis X. The toothed wheels 57 of each toothed rotor component 51, 52 are for example spaced along this axis X by the same distance, for example substantially equal to or less than the spacing distance d between the toothed rotor components 51, 52. All the toothed wheels 57, for example, have approximately the same thickness. Thus, along the encoder axis X, the toothed wheels 57 have a toothed longitudinal profile defined by a pitch P1 characterised by the thickness of the wheels 57, the spacing between these wheels 57 and the height of each tooth in a longitudinal section passing through the centre of these wheels 57. Advantageously, the wheels 57 have the same height of each tooth in each longitudinal section passing through the centre of these wheels 57.

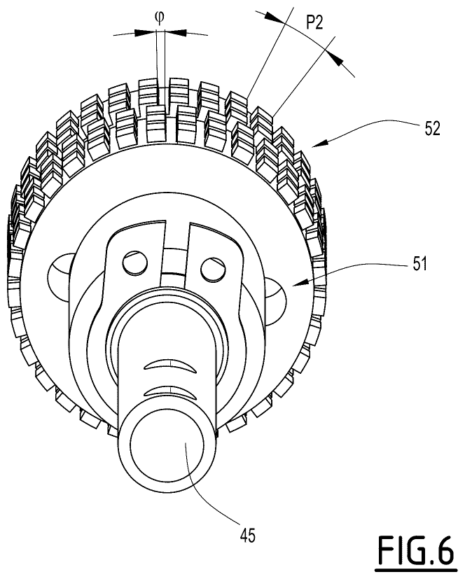

Each toothed wheel 57 also forms a plurality of teeth arranged circumferentially towards the outside of this wheel, for example at the same angular pitch P2. Each toothed wheel 57 has the same number of teeth arranged circumferentially, for example. These teeth are the same size, for example. In this way, each toothed wheel 57 forms the same toothed circumferential profile. In the example shown in FIG. 6, the number of teeth on each toothed wheel 57 is 32. This forms an angular pitch P2 equal to 11.25°.

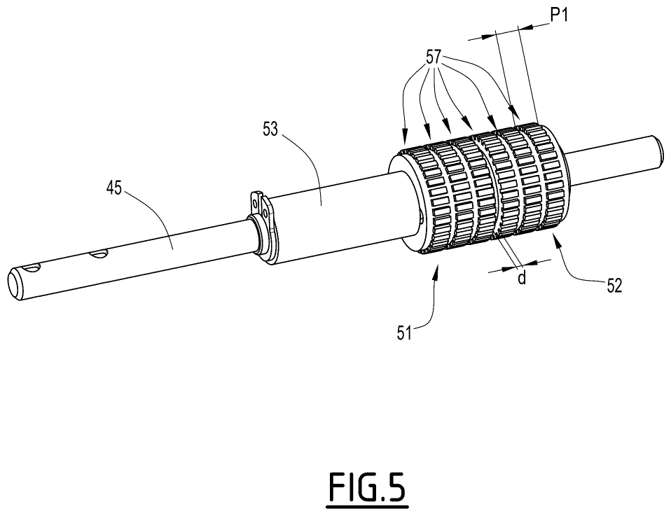

In the example shown in FIG. 5, each toothed rotor component 51, 52 comprises three toothed wheels 57. Each toothed rotor component 51, 52 comprises a central wheel and a pair of peripheral wheels. Furthermore, within the same toothed rotor component 51, 52, the toothed wheels 57 are advantageously arranged synchronously, i.e. in phase, along the encoder axis X. In other words, in this case, each tooth of a toothed wheel 57 is aligned along the encoder axis X with another tooth of an adjacent toothed wheel 57 within the same toothed rotor component 51, 52. On the other hand, between the different toothed rotor components 51, 52, the toothed wheels 57 are out of phase by a predetermined angle φ as shown in FIG. 6. This predetermined angle φ is, for example, a proportion of the angular pitch P2. This proportion is, for example, equal to %. Thus, in the example shown in FIG. 6, this angle φ may be substantially equal to 2.8125°.

Returning to the description in FIG. 4, the functional internals of the fixed body 22 comprise a toothed stator component 61, 62 for each toothed rotor component 51, 52 and fixing means 64 for fixing the toothed stator components 61, 62 to form the stator 41 as previously explained. In particular, the fixing means 64 enable each of the toothed stator components 61, 62 to be fixed immovably facing the corresponding toothed rotor component 51, 52, at least in a rest position of the encoder 10.

In the example shown in FIG. 4, the fixing means 64 comprise a spacing flange 67 enabling the toothed stator components 61, 62 to be spaced apart along the encoder axis X by a distance d, for example, and one or more fixing flanges 68 similar to the flange 43 as described above. The fixing means 64 further comprise a plurality of longitudinal screws (or threaded rods with nuts) 69 extending along the encoder axis X to assemble the fixing flanges 68, the spacing flange 67 and each of the toothed stator components 61, 62 along the encoder axis X. To this end, each flange 67, 68 and each toothed stator component 61, 62 can define opposing holes allowing one of the longitudinal screws 69 to pass through. The fixing flanges 68 can be made of a non-magnetic material such as aluminium or plastic. The flange 67 is advantageously made of a magnetic or ferromagnetic material because the magnetic flux, identified in FIG. 3, passes through it from part 61 to part 62. Of course, the fixing means 64 can be implemented in any other suitable form.

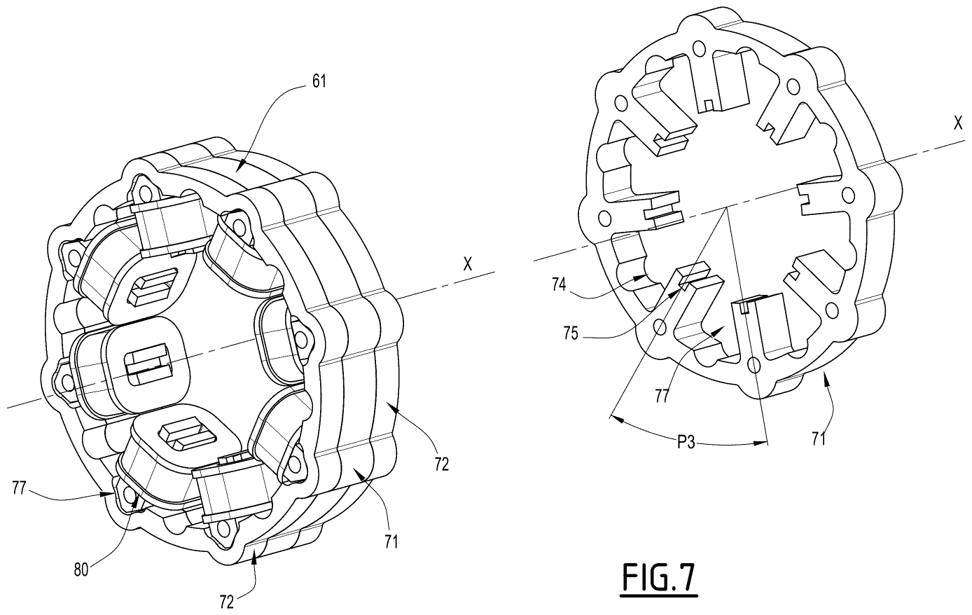

The toothed stator components 61, 62 are, for example, substantially similar to each other. The passage of the screws or threaded rods 69 through the corresponding holes thus ensures alignment of the stator teeth 61, 62. In the following, therefore, only the toothed stator component 61 will be described in detail with reference to FIG. 7.

Thus, as illustrated on the left hand side of this FIG. 7, the toothed stator component 61 comprises a central wheel 71 and a pair of peripheral wheels 72 adjacent opposite sides of the central wheel 71 along the encoder axis X. As can be seen on the right hand side of FIG. 7, the central wheel 71 defines a plurality of teeth 74 disposed inwardly of the central wheel 71. The teeth 74 are grouped together to form pairs. These pairs are arranged circumferentially and are evenly spaced from one another by the same angular pitch P3 in the circumferential direction. In particular, in the example shown in FIG. 7, the central wheel 71 defines eight pairs of teeth 74 arranged evenly in the circumferential direction. Each pair of teeth 74 is formed by two teeth extending along the encoder axis X and separated from each other by a cavity 75 also extending along the encoder axis X. The central wheel 71 thus defines a toothed circumferential profile.

Each pair of teeth 74 is configured to receive a magnetic coil 80 so that the windings of this magnetic coil 80 extend around this pair of teeth 74, i.e. around a radial axis connecting the centre of the central wheel 71 with its periphery. To do this, the pairs of teeth 74 define gaps 77 between them. Each gap 77 is configured to receive two halves of magnetic coils 80 extending around adjacent pairs of teeth 74 without these coils touching each other. In the example shown in FIG. 7, there are 8 magnetic coils arranged in the circumferential direction. In some embodiments, the magnetic coils 80 can be embedded in a fluid. Each magnetic coil 80 can have a winding of wires, for example of enamelled copper.

The peripheral wheels 72 are arranged on either side of the central wheel 71 so as to isolate the projecting ends of the magnetic coils 80 from the outer part of the stator 41. In other words, the thickness of the assembly of peripheral wheels 72 and central wheel 71 corresponds substantially to the longitudinal extension of the magnetic coils 80.

Each of the central wheel 71 and the peripheral wheel 72 is advantageously formed by a stack of plates or sheets made of a magnetic or ferromagnetic material. This allows eddy currents to be reduced, optimising performance and reducing power consumption, thereby improving efficiency.

The toothed stator components 61, 62 are configured to be at least partially opposite the toothed rotor components 51, 52 during each movement of the rotor 33 in each encoding direction C1, C2. In particular, for example in a rest position, the central wheels 71 of the toothed stator components 61, 62 are arranged facing the corresponding central wheels 57 of the toothed rotor components 51, 52. In a “push” or “pull” position of the rotor 33, the central wheels 71 of the toothed stator components 61, 62 face the corresponding peripheral wheels 57 of the toothed rotor components 51, 52. In each of these positions, the central wheels 71 of the toothed stator components 61, 62 are therefore positioned facing the toothed wheels 57 of the toothed rotor components 51, 52. The same applies when the rotor 33 is rotated relative to the stator 41.

Thus, each central wheel 71 of the toothed stator components 61, 62 is intended to cooperate magnetically with one of the toothed wheels 57 of the toothed rotor components 51, 52 as a function of the longitudinal position of the rotor 33. In addition, the circumferential tooth profiles of these wheels 71, 57 are synchronised. In other words, in such a case, each tooth of the or each toothed rotor component 51, 52 is in the same phase as its corresponding tooth on the toothed stator component 61, 62.

The magnetic coils 80 are configured to be energised so as to create a torque and/or a detent force during movement of the rotor 33 relative to the stator 41 and/or to detect and quantify each movement of the rotor 33 relative to the stator 41.

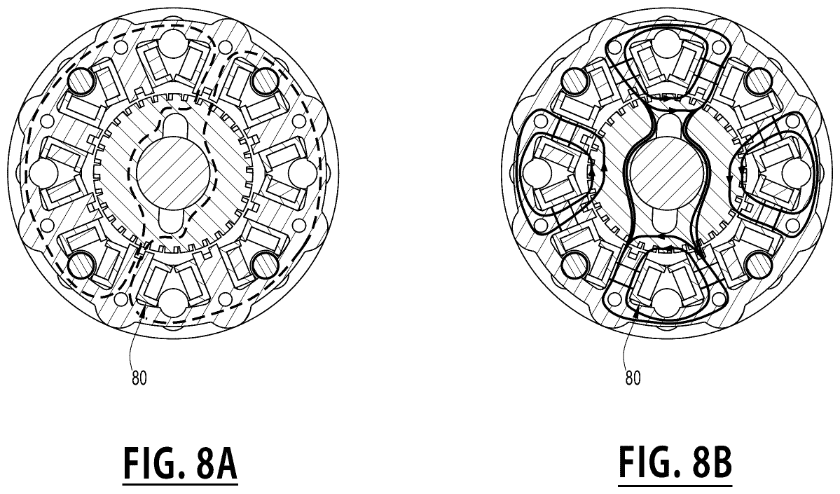

In particular, to create a detent torque and/or force, the magnetic coils 80 can be supplied with a constant current so that two groups of coils 80 form opposite polarities as shown in FIG. 8A. This energisation for the detent can be suppressed or reduced (set to standby) when the encoder 10 is not in use, so as not to consume energy unnecessarily in the idle phases. In addition, this device can also be used to vary the energisation of the coils in order to modify the detent depending on the context wherein the encoder is used (e.g. high torque during fine adjustment and very low potentiometer-type torque during coarse adjustment) or to generate haptic feedback (e.g. vibrating in direction C1 and/or direction C2 when an error is made or the wait time is too long, or to confirm an input, etc.).

The energisation mode shown FIG. 8A forms a magnetic flux, known as a long flux path. Alternatively, it is possible to energise the magnetic coils 80 using a short flux path to energise two adjacent magnetic coils 80, as shown in FIG. 8B.

The number of detent positions in each encoding direction is defined as a function of the corresponding toothed longitudinal/circumferential profiles. In particular, in the longitudinal direction, the number of detent positions is defined by the toothed longitudinal profile of the rotor 33. In the example shown, this number is equal to 3, which enables the “push” and “pull” functions of the encoder 10 to be provided. In the circumferential direction, the number of detent positions is defined by the corresponding circumferential tooth profiles. When these profiles are synchronised, the number of circumferential detent position is defined by the maximum number of teeth on these profiles (i.e. rotor or stator). Thus, in the example shown in the figures, the number of circumferential detent position is equal to 32 given that the toothed circumferential profile of each toothed wheel 57 of the toothed rotor components 51, 52 defines 32 teeth. When the circumferential tooth profiles are out of phase (i.e. when the teeth of one wheel are out of phase with the teeth of another wheel arranged facing this first wheel), the number of detent positions can be multiplied by a factor m corresponding to the number of different phases defined by these circumferential profiles.

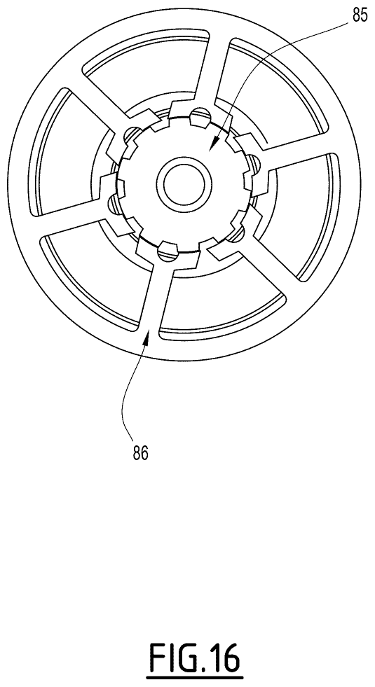

An example of out-of-phase circumferential tooth profiles is shown in FIG. 16. In this example, a toothed wheel 85 mounted on the rotor 33 has ten regularly spaced teeth and a toothed wheel 86 mounted on the stator 41 has six pairs of regularly spaced teeth and forms three different phases facing the teeth of the rotor 10. In this case, the number of circumferential detent position is 30.

To quantify each movement of the rotor 33 relative to the stator 41, the magnetic coils 80 are configured to detect variations in inductance created by the mutual displacement of the teeth of the different toothed wheels. Advantageously, the number of these variations detectable by the magnetic coils 80 corresponds to the number of detent positions in each encoding direction. In addition, the presence of several rotor and toothed stator components (two in the example shown) means that two detections can be carried out in each encoding direction and the direction of movement in each encoding direction can be determined. In particular, detection of the direction of rotation is made possible by the phase shift of the toothed wheels 57 between the different toothed rotor components. In addition, a specific longitudinal profile can be used to detect the direction of movement in the longitudinal direction.

To detect variations in inductance, according to one example, the magnetic coils 80 are energised with test signals consisting of periodic currents of particular shape, phase and frequency (at higher frequencies in the 1 kHz-1 Mhz range) which are superimposed on the coil supply current controlled at low frequency and on the DC current producing the periodic torque/force peaks of the detent. The position of the rotor 33 can therefore be determined by specific signal processing.

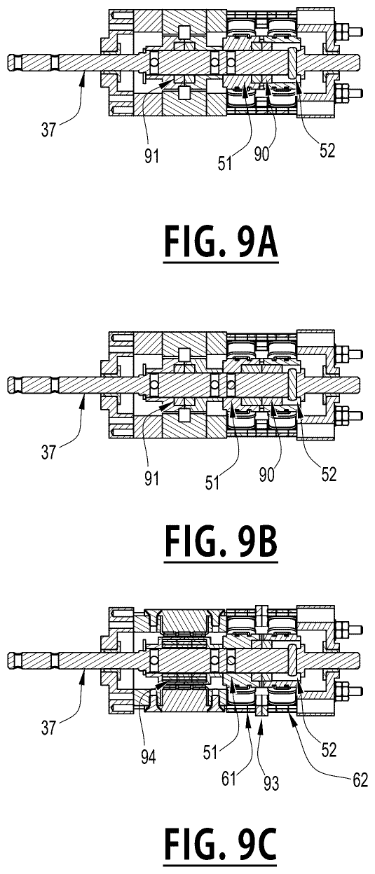

In some embodiments, the encoder 10 may further comprise additional detent means that are independent of the magnetic coils 80 as explained above. These may, for example, be passive means consisting of one or more permanent magnets. FIGS. 9A to 9B illustrate various examples of such additional detent means.

In the of FIG. 9A, at least one permanent magnet 90 is added between the toothed rotor components 51, 52 to increase the detent forces and torques in translation and rotation. The width of the permanent magnet 90 can be doubled to form a permanent magnet 92 as shown in the example of FIG. 9B.

In addition, in the examples of FIGS. 9A and 9B, a further translational detent device 91 is added. This device 91 significantly increases the translational force and ensures a return force in the central position to avoid the use of springs or to generate stable translational positions. This device 91 is preferably passive (no additional coil) and consists of one or more permanent magnets. The profiles of the teeth and/or magnets can be specific to ensure a force profile with improved tactile sensation. This additional device is made with magnetic or ferromagnetic parts to provide magnetic closing loops. The detent device 91 can consist of a magnet 91 added facing in a toothed system (two teeth on the rotor and two teeth on the stator equivalent to the flanges 68 but made from magnetic or ferromagnetic materials). This magnetic return device eliminates the need for a return spring in the central position.

In the example of FIG. 9C, a permanent magnet 93 is added between the toothed stator components 61, 62. In addition, in this example, the detent device as previously explained can comprise a plurality of magnets 94 with alternating magnetic poles can be added on the stator 41 and rotor 33 in their part between one of the toothed rotor components 51, 52 and the bearings 37 to form 1 to 3 stable positions and magnetic returns (as in the previous case) and avoid the use of a mechanical spring.

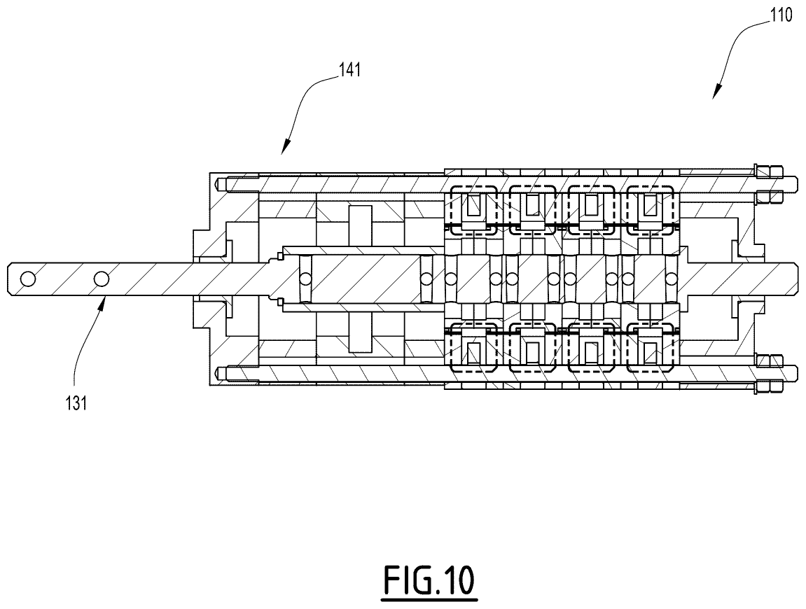

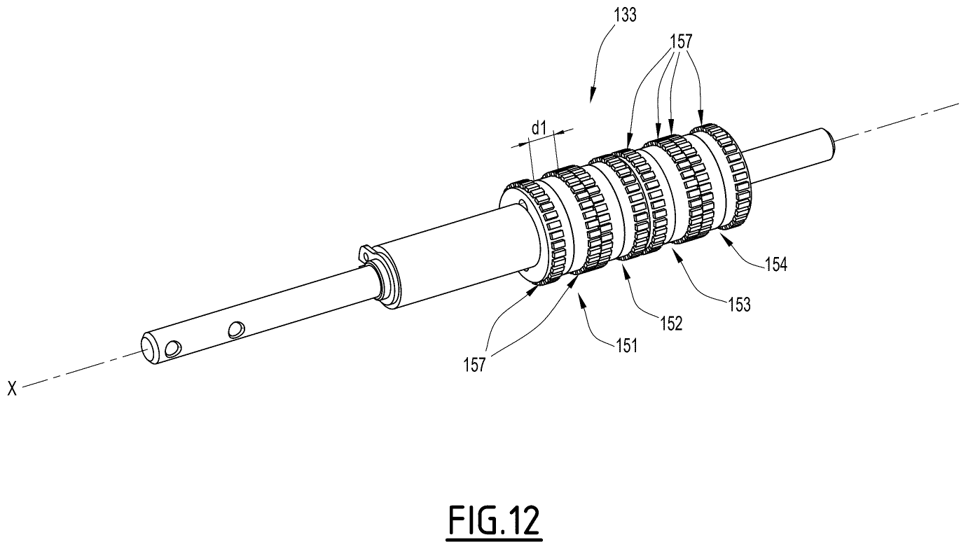

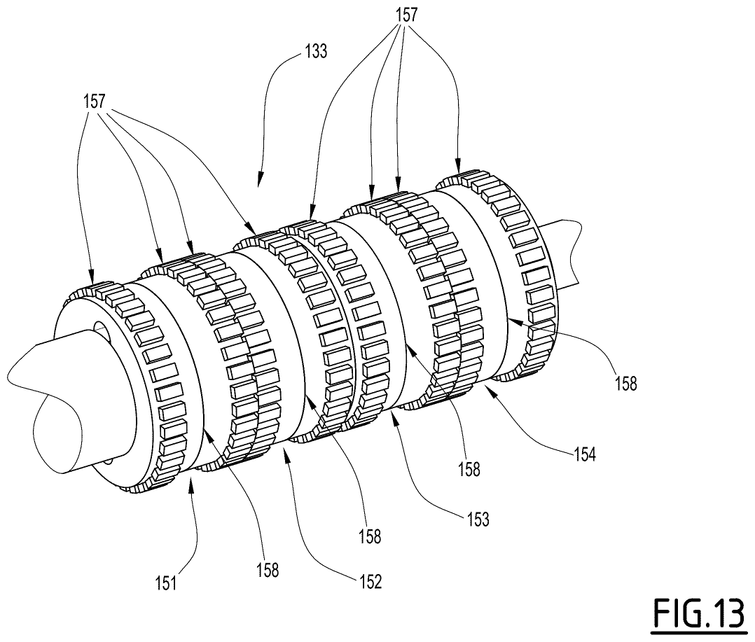

FIGS. 10 to 15 illustrate an incremental magnetic encoder 110 according to a second embodiment of the invention. This encoder 110 is substantially similar to that described above and is designed to be at least partially integrated into the panel 12, as shown in FIG. 1.

In addition, as shown in FIG. 10, the 110 encoder defines a rotor 133 and a stator 141 similar to those explained above. Only features that differ from the first embodiment of these elements will be explained below.

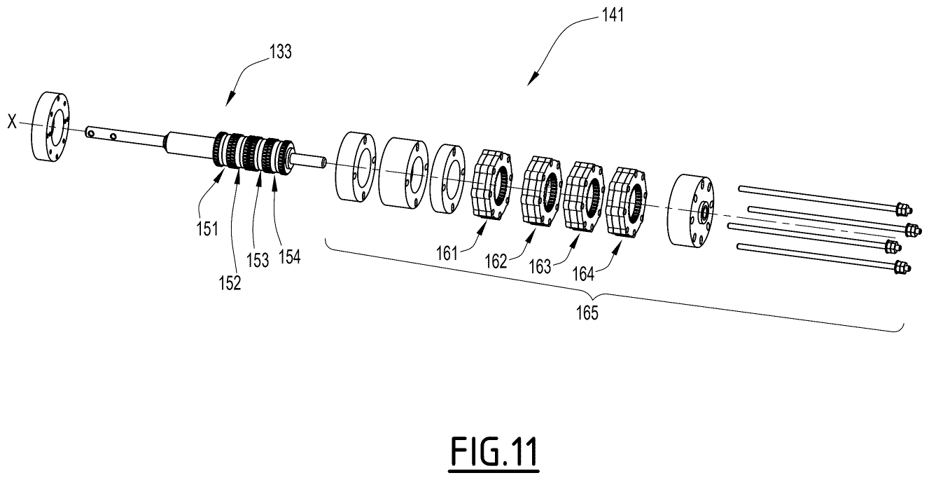

In particular, with reference to FIGS. 11 to 13, the rotor 133 defines a plurality of toothed rotor components 151 to 154 (four in the example of the Figures) arranged along the encoder axis X. Each toothed rotor component 151 to 154 comprises a pair of toothed wheels 157 spaced apart by a gap 158 of thickness d1. Each toothed wheel 157 is, for example, similar to the toothed wheel 57 of the toothed rotor components 51, 52 described in relation to the first embodiment. In particular, each toothed wheel 157 can define the same number of teeth as the toothed wheel 57 described above. The toothed wheels 157 of the same toothed rotor component 151 to 154 are synchronised (i.e. their teeth are aligned along the encoder axis X) and the toothed wheels 157 of adjacent toothed rotor components 151 to 154 are out of phase by a predetermined phase shift angle. This phase shift angle may be substantially equal to the phase shift angle cp described in relation to the first embodiment.

As can be seen in FIG. 11, the stator 141 comprises a toothed stator component 161 to 164 for each toothed rotor component 151 to 154 and means 165 for fixing these toothed stator components 161 to 164. The fixing means 165 are, for example, substantially similar to those described above and comprise, in particular, flanges, screws, etc. The toothed stator components 161 to 164 can thus be aligned along the encoder axis X.

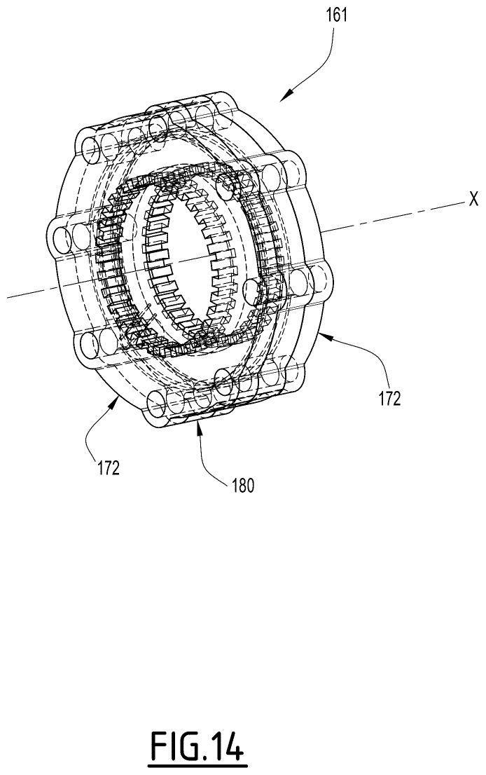

The toothed stator components 161 to 164 are arranged side by side along the encoder axis X to receive the respective toothed rotor components 151 to 154 when the encoder 110 is in its rest position. These toothed stator components 161 to 164 are, for example, substantially similar to each other and only toothed stator component 161 will be described in detail with reference to FIG. 14.

Thus, as illustrated in FIG. 14, the toothed stator component 161 comprises a magnetic coil 180 and a pair of peripheral toothed wheels 172 arranged axially with the magnetic coil 180, trapping this magnetic coil 180 between them.

Each peripheral toothed wheel 172 is intended to be arranged facing one of the toothed wheels 157 of the toothed rotor components 151 to 154. In addition, in the example shown, each peripheral toothed wheel 172 is in phase with each toothed wheel 157 of the toothed rotor components 151 to 154 and defines the same number of teeth, for example.

The magnetic coil 180 defines a winding around the encoder axis X extending between the peripheral toothed wheels 172. This coil 180 is designed to be positioned facing one of the spaces 158 in the toothed rotor components 151 to 154. Its thickness is therefore approximately equal to d1.

As in the previous embodiment, the magnetic coils 180 are configured to be energised so as to create a torque and/or a detent force during movement of the rotor 133 relative to the stator 141 and/or to detect and quantify each movement of the rotor 133 relative to the stator 141, in each encoding direction.

In particular, according to this embodiment, only one detection is carried out by each encoding direction. This detection can be implemented in a similar way to that explained above. In addition, the direction of rotation can be determined by the phase angle cp between the toothed wheels 157 of the various toothed rotor components 151 to 154. The direction of movement along the encoder axis X can be determined using a specific longitudinal toothed profile along this axis X and/or the detections made by the various magnetic coils 180 given their respective positions along the encoder axis X.

With regard to the detent torques, a specific energisation of the magnetic coils 180 enables 32 detents to be created in the circumferential direction and up to 4 detents in the longitudinal direction. This energisation for the detent can be suppressed or reduced (set to standby) when the 110 encoder is not in use, so as not to consume energy unnecessarily in the idle phase. In addition, this device can also be used to vary the energisation of the coils in order to modify the detent depending on the context wherein the encoder is used (e.g. high torque during fine adjustment and very low potentiometer-type torque during coarse adjustment) or to generate haptic feedback (e.g. vibrating in direction C1 and/or direction C2 when an error is made or the wait time is too long, or to confirm an input, etc.).

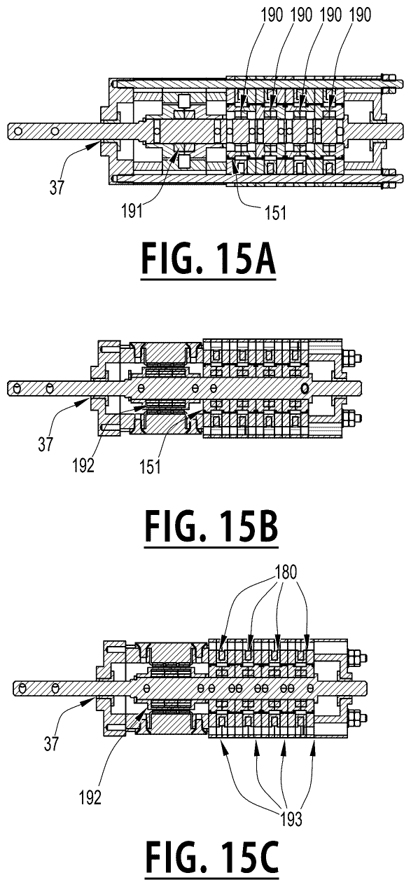

Finally, as in the previous case, in certain embodiments, the encoder 110 may also comprise additional detent means which are independent of the magnetic coils 180 as explained above. These may, for example, be passive means consisting of one or more permanent magnets. FIGS. 15A to 15C illustrate various examples of such additional detent means.

Thus, in the example of FIG. 15A, a permanent magnet 190 is added in each space 158 formed between a pair of toothed wheels 157 of the toothed rotor components 151 to 154, to increase the translational and rotational locking forces and torques. In addition, a magnet 191 can be added facing in a toothed system (2 rotor teeth and 2 stator teeth equivalent to flanges 68 but made of magnetic or ferromagnetic material). In order to form an axial detent and return forces in a stable push/pull position. This avoids the use of mechanical springs.

In addition, in the examples if FIGS. 15B and 15C, an additional translational detent device 192 is added. This device 192 significantly increases the translational force and provides a return force in the central position to avoid the use of springs or to generate stable translational positions. This device 192 is preferably passive (no additional coil) and consists of a plurality of permanent magnets. The profiles of the teeth and/or magnets can be specific to ensure a force profile with improved tactile sensation. This additional device is made with magnetic or ferromagnetic parts defining alternating magnetic poles, to ensure magnetic closing loops. These magnetic parts are added to the stator 141 and rotor 133 in the area between the toothed rotor component 151 and the bearings 37. This magnetic return device eliminates the need for a return spring in the central position.

In the example of FIG. 15C, a permanent magnet 193 is added between the yokes of each magnetic coil 180.

1. An incremental magnetic encoder defining an encoder axis and comprising a fixed body and a body movable relative to the fixed body in at least one first encoding direction;
one of the bodies, referred to as the first body, comprising:
a first toothed component extending along a longitudinal direction coincident with the encoder axis and a circumferential direction perpendicular to the longitudinal direction, one of said directions corresponding to the first encoding direction, the first toothed component defining a plurality of teeth made of magnetic or ferromagnetic material and arranged along the first encoding direction;
the other body, referred to as the second body, comprising:
a second toothed component extending in the longitudinal direction and the circumferential direction, the second toothed component defining a tooth made of magnetic or ferromagnetic material and arranged facing the teeth of the first toothed component during each movement of the movable body in the first encoding direction;
at least one pair of magnetic coils configured to measure each variation in inductance between the first toothed component and the second toothed component, to quantify each movement of the movable body in the first encoding direction;
the magnetic coils being further configured to be energised during operation of the encoder, to create a torque or a detent force between the first toothed component and the second toothed component during each respective movement of these components in the first encoding direction.

2. The encoder according to claim 1, wherein the teeth of the first toothed component are arranged along the first encoding direction at a constant pitch.

3. The encoder according to claim 1, wherein:
the first encoding direction corresponds to the circumferential direction;
the second toothed component comprises a plurality of teeth arranged in the circumferential direction facing the teeth of the first toothed component synchronously or out of phase.

4. The encoder according to claim 1, wherein the movable body is movable relative to the fixed body in a second encoding direction perpendicular to the first encoding direction;
the first toothed component further defining a plurality of teeth made of magnetic or ferromagnetic material and arranged along the second encoding direction;
the second toothed component defining a tooth made of magnetic or ferromagnetic material and arranged facing the teeth of the first toothed component during each movement of the movable body in the second encoding direction;
at least one pair of magnetic coils being configured to measure each variation in inductance between the first toothed component and the second toothed component, in order to quantify each movement of the movable body in the second encoding direction.

5. The encoder according to claim 1, wherein the first toothed component comprises a plurality of toothed wheels arranged along the encoder axis.

6. The encoder according to claim 5, wherein the toothed wheels are spaced apart to form a plurality of teeth along the encoder axis.

7. The encoder according to claim 5, wherein the second toothed component comprises at least one toothed wheel arranged coaxially with at least one toothed wheel of the first toothed component at least in a rest position of the encoder.

8. The encoder according to claim 7, comprising a plurality of magnetic coils arranged circumferentially on the toothed wheel of the second toothed component;
each magnetic coil extending around a pair of teeth formed by the toothed wheel of the second toothed component.

9. The encoder according to claim 7, wherein:
the second toothed component comprises at least two toothed wheels arranged along the encoder axis;
at least one magnetic coil is disposed between said toothed wheels of the second toothed component and extends around the encoder axis.

10. The encoder according to claim 1, comprising at least two first toothed components arranged along the encoder axis and at least two second toothed components arranged coaxially with the first toothed components.

11. The encoder according to claim 10, wherein:
each first toothed component comprises at least one toothed wheel;
the toothed wheels corresponding to different first toothed components are out of phase by a predetermined angle.

12. The encoder according to claim 1, wherein the magnetic coils are configured so as to be energised during operation of the encoder, in order to create a detent torque or force between the first toothed component and the second toothed component during each respective movement of these components in a second encoding direction.

13. The encoder according to claim 12, wherein the magnetic coils are configured to be energised as a function of a context of use of the encoder or to generate haptic feedback.

14. The encoder according to claim 12, wherein the number of detent positions in an encoding direction is determined by the number of teeth of the first toothed component or of the second toothed component along this encoding direction.

15. The encoder according to claim 12, further comprising one or more permanent magnets arranged to enhance the detent torque and/or force and/or generate a return torque and/or force.
